(19) United States
(12) Patent Application Publication
(10) Pub. No.: US 2021/0344196 A1
(43) Pub. Date: Nov. 4, 2021

(54) METHOD FOR ADJUSTING POWER FLOW BASED ON OPERATION CONSTRAINTS

(71) Applicant: Tsinghua University, Beijing (CN)

(72) Inventors: Bin WANG, Beijing (CN); Hongbin SUN, Beijing (CN); Wenchuan WU, Beijing (CN); Qinglai GUO, Beijing (CN); Zongda MU, Beijing (CN)

(21) Appl. No.: 17/240,561

(22) Filed: Apr. 26, 2021

(30) Foreign Application Priority Data
Apr. 29, 2020 (CN) 202010353029.3

(51) Int. Cl. H02J 3/12; G05B 13/04

(52) U.S. Cl. CPC H02J 3/12; H02J 2203/20; H02J 2203/10; G05B 13/042

(57) ABSTRACT

Provided are method and device for adjusting a power flow based on operation constraints. The method includes: establishing a power flow adjusting model comprising an objective function and constraints; acquiring active power and reactive power of each node by using a two-stage optimization of active and reactive powers. In this method, the power flow adjusting model is divided into the active power optimization sub-model and the reactive power optimization sub-model. The active power optimization sub-model, where the linearized power flow constraint and the tie line section active power constraint are considered, may be regarded as quadratic programming. The reactive power flow optimization sub-model is solved on the basis of the active sub-model, and the AC power flow constraint, the grid voltage range constraint, and the pilot bus voltage setting value constraint are considered.

### CROSS-REFERENCE TO RELATED APPLICATION

This application claims priority to and benefits of Chinese Patent Application Serial No. 202010353029.3, filed with the National Intellectual Property Administration of P. R. China on Apr. 29, 2020, the entire content of which is incorporated herein by reference.

### FIELD

The present disclosure relates to a field of power system operation technologies, and more particularly to a method for adjusting a power flow generation based on operation constraint.

### BACKGROUND

Power flow calculation is the basis of power system stability calculation and fault analysis. Existing power flow adjustment technology forms a new power flow distribution by changing boundaries of the base-state power flow, such as active/reactive power of a PQ node and active power/voltage amplitude of a PV node, or by changing topological parameters such as switching state and tap gear. However, this adjustment is limited in a relative complex case when a pilot bus voltage tracks a certain value or when a transmission section power tracks a certain value. In this case, the existing power flow means will not be applicable, and manual experience is always introduced in the existing method, which needs additional time and labor and still may not result in desired feasibility and optimization.

### SUMMARY

Embodiments of the present disclosure seek to solve at least one of the problems existing in the related art to at least some extent.

In a first aspect of embodiments of the present disclosure, a method for adjusting a power flow based on operation constraints is provided. The method includes:

(1) establishing a power flow adjusting model including an objective function and constraints, including:

(1-1) determining the objective function of the model having a formula of

$${min}_{V , θ , Δ {P}_{i}^{G} , Δ {Q}_{i}^{G}} {\sum }_{i = 1}^{N} {{λ}_{i}^{PG} ( Δ {P}_{i}^{G} )}^{2} + {{λ}_{i}^{QG} ( Δ {Q}_{i}^{G} )}^{2}$$

where N represents the number of nodes, i represents a node number, V represents a voltage amplitude, θ represents a voltage phase angle, ΔPᵢ^{G} represents an optimal adjustment amount of an active power injected into node i, ΔQᵢ^{G} represents an optimal adjustment amount of a reactive power injected into node i, λᵢ^{PG} represents an adjustment weight of the active power injected into node i, and λᵢ^{QG} represents an adjustment weight of the reactive power injected into node i;

(1-2) determining the constraints of the model, the constraints including:

(1-2-1) a power flow constraint having formulas of

$${P}_{i} + Δ {P}_{i}^{G} = {V}_{i}^{2} {G}_{ii} + {\sum }_{j ∈ i}^{j \neq i} {V}_{i} {V}_{j} ( {G}_{ij} cos {θ}_{ij} + {B}_{ij} sin {θ}_{ij} )$$

$${Q}_{i} + Δ {Q}_{i}^{G} = - {V}_{i}^{2} {B}_{ii} + {\sum }_{j ∈ i}^{j \neq i} {V}_{i} {V}_{j} ( {G}_{ij} sin {θ}_{ij} - {B}_{ij} cos {θ}_{ij} )$$

where j∈i represents that node j belongs to a set of all nodes connected to node i, Gᵢⱼ and Bᵢⱼ represent a real part and an imaginary part of an upper triangular element of a node admittance matrix, respectively, Gᵢᵢ and Bᵢᵢ represent a real part and an imaginary part of a diagonal element of the node admittance matrix, respectively, Vᵢ represents a voltage amplitude of node i, θᵢⱼ represents a phase angle difference of branch ij, Pᵢ represents an active power injected into node i at a base state, and Qᵢ represents a reactive power injected into node i at a base state;

(1-2-2) a grid voltage range constraint having a formula of

Vᵢ≤Vᵢ≤V̅ᵢ̅

where Vᵢ and V̅ᵢ̅ represent a lower limit and an upper limit of a voltage amplitude of node i, respectively;

(1-2-3) a voltage setting value constraint of a pilot bus, having a formula of

Vⱼ^{p}=\hat{V}ⱼ^{p}

where Vⱼ^{p} and \hat{V}ⱼ^{p} represent an optimized voltage value and a set voltage value of an j^{th} pilot bus, respectively;

(1-2-4) a sectional transmission power constraint having formulas of

Pₖ^{Td}=\hat{P}ₖ^{Td}

Pₘ^{Tc}≤Pₘ^{Tc}≤P̅ₘ̅^̅{̅T̅c̅}̅

where Pₖ^{Td} and \hat{P}ₖ^{Td} represent an optimized power value and a set power value of a k^{th} target tie line, respectively, Pₘ^{Tc}, Pₘ^{Tc} and P̅ₘ̅^̅{̅T̅c̅}̅ represent a power lower limit, an optimized power value and a power upper limit of an m^{th} constrained tie line, respectively;

(2) acquiring active power and reactive power of each node by using a two-stage optimization of active and reactive powers, including:

(2-1) establishing an active power optimization sub-model including an objective function and constraints, including:

(2-1-1) determining the objective function of the active power optimization sub-model having a formula of

$${min}_{θ , Δ {P}_{i}^{G}} {\sum }_{i = 1}^{N} {{λ}_{i}^{PG} ( Δ {P}_{i}^{G} )}^{2}$$

(2-1-2) determining the constraints of the active power optimization sub-model, the constraints including:

(2-1-2-1) a linearized power flow constraint having a formula of

$${P}_{i} + Δ {P}_{i}^{G} = {V}_{i}^{2} {G}_{ii} + {\sum }_{j ∈ i}^{j \neq i} {V}_{i} {V}_{j} ( {G}_{ij} + {B}_{ij} {θ}_{ij} )$$

(2-1-2-2) a tie line section power flow constraint having formulas of

Pₘ^{Tc}≤Pₘ^{Tc}≤P̅ₘ̅^̅{̅T̅c̅}̅

Pₖ^{Td}=\hat{P}ₖ^{Td}

(2-2) solving the active power optimization sub-model to acquire optimal solutions of ΔPᵢ^{G} and θ;

(2-3) establishing a reactive power optimization sub-model including an objective function and constraints, including:

(2-3-1) determining the objective function of the reactive power optimization sub-model having a formula of

$${min}_{V , θ , Δ {Q}_{i}^{G} , Δ f} {\sum }_{i = 1}^{N} {{λ}_{i}^{QG} ( Δ {Q}_{i}^{G} )}^{2}$$

where Δf represents a frequency variation, wherein the optimal solution of θ obtained by solving the active optimization sub-model is used as an initial value;

(2-3-2) determining the constraints of the reactive power optimization sub-model, the constraints including:

(2-3-2-1) an AC power flow constraint having formulas of

$${P}_{i} + Δ {P}_{i}^{G} + Δ f \cdot {P}_{i}^{agc} = {V}_{i}^{2} {G}_{ii} + {\sum }_{j ∈ i}^{j \neq i} {V}_{i} {V}_{j} ( {G}_{ij} cos {θ}_{ij} + {B}_{ij} sin {θ}_{ij} ) \\ {Q}_{i} + Δ {Q}_{i}^{G} = - {V}_{i}^{2} {B}_{ii} + {\sum }_{j ∈ i}^{j \neq i} {V}_{i} {V}_{j} ( {G}_{ij} sin {θ}_{ij} - {B}_{ij} cos {θ}_{ij} )$$

where Pᵢ^{agc} represents an unbalanced power analysis coefficient of node i participating in frequency response;

(2-3-2-2) a grid voltage range constraint having a formula of

Vᵢ≤Vᵢ≤V̅ᵢ̅

(2-3-2-3) a voltage setting value constraint of a pilot bus, having a formula of

Vⱼ^{p}=\hat{V}ⱼ^{p}

(2-4) solving the reactive power optimization sub-model to acquire an optimal solution of ΔQᵢ^{G};

(2-5) acquiring the active power \hat{P}ᵢ and the reactive power \hat{Q}ᵢ of each node according to the optimal solutions of ΔPᵢ^{G} and ΔQᵢ^{G}:

$$\{ \begin{matrix}{\hat{P}}_{i} = {P}_{i} + Δ {P}_{i}^{G} + Δ f \cdot {P}_{i}^{agc} \\ {\hat{Q}}_{i} = {Q}_{i} + Δ {Q}_{i}^{G}\end{matrix} .$$

In a second aspect of embodiments of the present disclosure, a device for adjusting a power flow based on operation constraints is provided. The device includes a processor, and a memory having stored therein a computer program that, when executed by the processor, causes the processor to perform the method as described in the first aspect.

In a third aspect of embodiments of the present disclosure, a computer-readable storage medium having stored therein instructions that, when executed by a processor, are configured to perform the method the method as described in the first aspect.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

The present disclosure provides in embodiments a method for adjusting power flow which is able to be used in various applications such as dispatcher power flow analysis, online security correction control, scheduling plan modification, and offline power flow mode generation and is capable of calculating and adjusting the power flow and ensuring that there is a feasible solution in the cases when a pilot bus voltage tracks a certain value or when a transmission section power tracks a certain value.

The present disclosure provides in embodiments a method for adjusting a power flow based on operation constraints, including:

(1) establishing a power flow adjusting model including an objective function and constraints, including:

(1-1) determining the objective function of the model having a formula of

$${min}_{V , θ , Δ {P}_{i}^{G} Δ {Q}_{i}^{G}} {\sum }_{i = 1}^{N} {{λ}_{i}^{PG} ( Δ {P}_{i}^{G} )}^{2} + {{λ}_{i}^{QG} ( Δ {Q}_{i}^{G} )}^{2}$$

where N represents the number of nodes, i represents a node number, V represents a voltage amplitude, θ represents a voltage phase angle, ΔPᵢ^{G} represents an optimal adjustment amount of an active power injected into node i, ΔQᵢ^{G} represents an optimal adjustment amount of a reactive power injected into node i, λᵢ^{PG} represents an adjustment weight of the active power injected into node i, and λᵢ^{QG} represents an adjustment weight of the reactive power injected into node i;

(1-2) determining the constraints of the model, the constraints including:

(1-2-1) a power flow constraint having formulas of

$${P}_{i} + Δ {P}_{i}^{G} = {V}_{i}^{2} {G}_{ii} + {\sum }_{j ∈ i}^{j \neq i} {V}_{i} {V}_{j} ( {G}_{ij} cos {θ}_{ij} + {B}_{ij} sin {θ}_{ij} )$$

$${Q}_{i} + Δ {Q}_{i}^{G} = - {V}_{i}^{2} {B}_{ii} + {\sum }_{j ∈ i}^{j \neq i} {V}_{i} {V}_{j} ( {G}_{ij} sin {θ}_{ij} - {B}_{ij} cos {θ}_{ij} )$$

where j∈i represents that node j belongs to a set of all nodes connected to node i, Gᵢⱼ and Bᵢⱼ represent a real part and an imaginary part of an upper triangular element of a node admittance matrix, respectively, Gᵢᵢ and Bᵢᵢ represent a real part and an imaginary part of a diagonal element of the node admittance matrix, respectively, Vᵢ represents a voltage amplitude of node i, θᵢⱼ represents a phase angle difference of branch ij, Pᵢ represents an active power injected into node i at a base state, and Qᵢ represents a reactive power injected into node i at a base state;

(1-2-2) a grid voltage range constraint having a formula of

Vᵢ≤Vᵢ≤V̅ᵢ̅

where Vᵢ and V̅ᵢ̅ represent a lower limit and an upper limit of a voltage amplitude of node i, respectively;

(1-2-3) a voltage setting value constraint of a pilot bus, having a formula of

Vⱼ^{p}=\hat{V}ⱼ^{p}

where Vⱼ^{p} and \hat{V}ⱼ^{p} represent an optimized voltage value and a set voltage value of an j^{th} pilot bus, respectively;

(1-2-4) a sectional transmission power constraint having formulas of

Pₖ^{Td}=\hat{P}ₖ^{Td}

Pₘ^{Tc}≤Pₘ^{Tc}≤P̅ₘ̅^̅{̅T̅c̅}̅

where Pₖ^{Td} and \hat{P}ₖ^{Td} represent an optimized power value and a set power value of a k^{th} target tie line, respectively, Pₘ^{Tc}, Pₘ^{Tc} and P̅ₘ̅^̅{̅T̅c̅}̅ represent a power lower limit, an optimized power value and a power upper limit of an m^{th} constrained tie line, respectively;

(2) acquiring active power and reactive power of each node by using a two-stage optimization of active and reactive powers, including:

(2-1) establishing an active power optimization sub-model including an objective function and constraints, including:

(2-1-1) determining the objective function of the active power optimization sub-model having a formula of

$${min}_{θ , Δ {P}_{i}^{G}} {\sum }_{i = 1}^{N} {{λ}_{i}^{PG} ( Δ {P}_{i}^{G} )}^{2}$$

(2-1-2) determining the constraints of the active power optimization sub-model, the constraints including:

(2-1-2-1) a linearized power flow constraint having a formula of

$${P}_{i} + Δ {P}_{i}^{G} = {V}_{i}^{2} {G}_{ii} + {\sum }_{j ∈ i}^{j \neq i} {V}_{i} {V}_{j} ( {G}_{ij} + {B}_{ij} {θ}_{ij} )$$

(2-1-2-2) a tie line section power flow constraint having formulas of

Pₘ^{Tc}≤Pₘ^{Tc}≤P̅ₘ̅^̅{̅T̅c̅}̅

Pₖ^{Td}=\hat{P}ₖ^{Td}

(2-2) solving the active power optimization sub-model to acquire optimal solutions of ΔPᵢ^{G} and θ;

(2-3) establishing a reactive power optimization sub-model including an objective function and constraints, including:

(2-3-1) determining the objective function of the reactive power optimization sub-model having a formula of

$${min}_{V , θ , Δ {Q}_{i}^{G} , Δ f} {\sum }_{i = 1}^{N} {{λ}_{i}^{QG} ( Δ {Q}_{i}^{G} )}^{2}$$

where Δf represents a frequency variation, wherein the optimal solution of θ obtained by solving the active optimization sub-model is used as an initial value;

(2-3-2) determining the constraints of the reactive power optimization sub-model, the constraints including:

(2-3-2-1) an AC power flow constraint having formulas of

$${P}_{i} + Δ {P}_{i}^{G} + Δ f \cdot {P}_{i}^{agc} = {V}_{i}^{2} {G}_{ii} + {\sum }_{j ∈ i}^{j \neq i} {V}_{i} {V}_{j} ( {G}_{ij} cos {θ}_{ij} + {B}_{ij} sin {θ}_{ij} ) \\ {Q}_{i} + Δ {Q}_{i}^{G} = - {V}_{i}^{2} {B}_{ii} + {\sum }_{j ∈ i}^{j \neq i} {V}_{i} {V}_{j} ( {G}_{ij} sin {θ}_{ij} - {B}_{ij} cos {θ}_{ij} )$$

where Pᵢ^{agc} represents an unbalanced power analysis coefficient of node i participating in frequency response;

(2-3-2-2) a grid voltage range constraint having a formula of

Vᵢ≤Vᵢ≤V̅ᵢ̅

(2-3-2-3) a voltage setting value constraint of a pilot bus, having a formula of

Vⱼ^{p}=\hat{V}ⱼ^{p}

(2-4) solving the reactive power optimization sub-model to acquire an optimal solution of ΔQᵢ^{G};

(2-5) acquiring the active power \hat{P}ᵢ and the reactive power \hat{Q}ᵢ of each node according to the optimal solutions of ΔPᵢ^{G} and Δᵢ^{G}:

$$\{ \begin{matrix}{\hat{P}}_{i} = {P}_{i} + Δ {P}_{i}^{G} + Δ f \cdot {P}_{i}^{agc} \\ {\hat{Q}}_{i} = {Q}_{i} + Δ {Q}_{i}^{G}\end{matrix} .$$

In an embodiment, the adjustment weight of the active power is in a range of 0 to 1.

In an embodiment, the adjustment weight of the reactive power is in a range of 0 to 1.

In an embodiment, the active power optimization sub-model is solved by a linear programming algorithm.

In an embodiment, the unbalanced power analysis coefficient is a total capacity of a generator unit connected to node i.

With the method for adjusting power flow of the present application, the power flow adjusting model is established with the operation constraints. In the present method, the adjustment amount is relative small, and the result solved from the model meets the operation constraints such as the grid voltage range constraint, the sectional transmission power constraint, and the voltage setting value constraint of the pilot bus. In the method for adjusting power flow of the present application, the active power and the reactive power are optimized separately. The power flow adjusting model is divided into the active power optimization sub-model and the reactive power optimization sub-model. The active power optimization sub-model, where the linearized power flow constraint and the tie line section active power constraint are considered, may be regarded as quadratic programming and thus has a high convergence. The reactive power flow optimization sub-model is solved on the basis of the active sub-model, and the AC power flow constraint, the grid voltage range constraint, and the pilot bus voltage setting value constraint are considered, thus improving the feasibility of the result calculated. Therefore, the present method may realize the power flow calculation when the pilot bus voltage tracks a certain value and when the transmission section power tracks a certain value, reducing the labor of the manual adjustment and achieving a feasible optimal solution.

The method for adjusting a power flow based on operation constraints of the present disclosure will be described as follows.

The method for adjusting the power flow based on operation constraints includes the following steps.

In step (1), a power flow adjusting model including an objective function and constraints is established. The step (1) includes a step (1-1), determining the objective function of the model having a formula of

$${min}_{V , θ , Δ {P}_{i}^{G} , Δ {Q}_{i}^{G}} {\sum }_{i = 1}^{N} {{λ}_{i}^{PG} ( Δ {P}_{i}^{G} )}^{2} + {{λ}_{i}^{QG} ( Δ {Q}_{i}^{G} )}^{2}$$

where N represents the number of nodes, i represents a node number, V represents a voltage amplitude, θ represents a voltage phase angle, ΔPᵢ^{G} represents an optimal adjustment amount of an active power injected into node i, ΔQᵢ^{G} represents an optimal adjustment amount of a reactive power injected into node i, λᵢ^{PG} represents an adjustment weight of the active power injected into node i, and λᵢ^{QG} represents an adjustment weight of the reactive power injected into node i.

The adjustment weight is in a range of 0 to 1. When the weight is 0, the active/reactive power corresponding to the weight does not participate in the adjustment.

In step (1-2), the constraints of the model are determined. The constraints includes a power flow (1-2-1), a grid voltage range constraint (1-2-2), a voltage setting value constraint (1-2-3) of a pilot bus and a sectional transmission power constraint (1-2-4).

(1-2-1) The power flow constraint has formulas of

$${P}_{i} + Δ {P}_{i}^{G} = {V}_{i}^{2} {G}_{ii} + {\sum }_{j ∈ i}^{j \neq i} {V}_{i} {V}_{j} ( {G}_{ij} cos {θ}_{ij} + {B}_{ij} sin {θ}_{ij} )$$

$${Q}_{i} + Δ {Q}_{i}^{G} = - {V}_{i}^{2} {B}_{ii} + {\sum }_{j ∈ i}^{j \neq i} {V}_{i} {V}_{j} ( {G}_{ij} sin {θ}_{ij} - {B}_{ij} cos {θ}_{ij} )$$

where j∈i represents that node j belongs to a set of all nodes connected to node i, Gᵢⱼ and Bᵢⱼ represent a real part and an imaginary part of an upper triangular element of a node admittance matrix, respectively, Gᵢᵢ and Bᵢᵢ represent a real part and an imaginary part of a diagonal element of the node admittance matrix, respectively, Vᵢ represents a voltage amplitude of node i, θᵢⱼ represents a phase angle difference of branch ij, Pᵢ represents an active power injected into node i at a base state, and Qᵢ represents a reactive power injected into node i at a base state.

(1-2-2) The grid voltage range constraint has a formula of

Vᵢ≤Vᵢ≤V̅ᵢ̅

where Vᵢ and V̅ᵢ̅ represent a lower limit and an upper limit of a voltage amplitude of node i, respectively.

(1-2-3) The voltage setting value constraint of a pilot bus has a formula of

Vⱼ^{p}=\hat{V}ⱼ^{p}

where Vⱼ^{p} and \hat{V}ⱼ^{p} represent optimized voltage value and set voltage value of an j^{th} pilot bus, respectively.

(1-2-4) The sectional transmission power constraint has formulas of

Pₖ^{Td}=\hat{P}ₖ^{Td}

Pₘ^{Tc}≤Pₘ^{Tc}≤P̅ₘ̅^̅{̅T̅c̅}̅

where Pₖ^{Td} and \hat{P}ₖ^{Td} represent an optimized power value and a set power value of a k^{th} target tie line, respectively, Pₘ^{Tc}, Pₘ^{Tc} and P̅ₘ̅^̅{̅T̅c̅}̅ represent a power lower limit, an optimized power value and a power upper limit of an m^{th} constrained tie line, respectively. The target tie line refers to a tie line of which a power optimization value tracks a target setting value. The constrained tie line refers to a tie line of which a power optimization value is between the upper limit and the lower limit.

In step (2), active power and reactive power of each node are acquired by using a two-stage optimization of active and reactive powers. The acquired node having the active and reactive powers meets the power flow result, i.e., meets the objective function of the power flow adjusting model.

During the operation of the power grid, if it is close to operation boundaries or the disturbance is relatively large, the function of the power flow adjusting model may be divergent. The present disclosure provides a joint optimization strategy, which combines the active power optimization and the reactive power optimization. First, the active power optimization is performed to obtain the voltage phase angle and the optimal adjustment amount of the active power. Then, the voltage phase angle is brought into the reactive power optimization to obtain the optimal adjustment amount of the reactive power.

The step (2) may include the following steps.

In step (2-1), an active power optimization sub-model including an objective function and constraints is established by (2-1-1) determining the objective function of the active power optimization sub-model having a formula of

$${min}_{θ , Δ {P}_{i}^{G}} {\sum }_{i = 1}^{N} {{λ}_{i}^{PG} ( Δ {P}_{i}^{G} )}^{2} ,$$

and (2-1-2) determining the constraints of the active power optimization sub-model. In the active power optimization sub-model, an adjustment of an active output of a generator is regarded as an optimization variable, and a minimum of a sum of weighted adjustment amount square is regarded as the goal.

The constraints considered in the active power optimization sub-model includes a linearized power flow constraint (2-1-2-1) and a tie line section power flow constraint (2-1-2-2).

(2-1-2-1) The linearized power flow constraint has a formula of

$${P}_{i} + Δ {P}_{i}^{G} = {V}_{i}^{2} {G}_{ii} + {\sum }_{j ∈ i}^{j \neq i} {V}_{i} {V}_{j} ( {G}_{ij} + {B}_{ij} {θ}_{ij} ) .$$

(2-1-2-2) The tie line section power flow constraint has formulas of

Pₘ^{Tc}≤Pₘ^{Tc}≤P̅ₘ̅^̅{̅T̅c̅}̅,

Pₖ^{Td}=\hat{P}ₖ^{Td}.

In step (2-2), the active power optimization sub-model is solved to acquire optimal solutions of ΔPᵢ^{G} and θ. For example, the active power optimization sub-model is solved by a linear programming algorithm.

In step (2-3), a reactive power optimization sub-model including an objective function and constraints is established by (2-3-1) determining the objective function of the reactive power optimization sub-model having a formula of

$${min}_{V , θ , Δ {Q}_{i}^{G} , Δ f} {\sum }_{i = 1}^{N} {{λ}_{i}^{QG} ( Δ {Q}_{i}^{G} )}^{2} ,$$

where Δf represents a frequency variation, and (2-3-2) determining the constraints of the reactive power optimization sub-model.

The optimal phase angle value θ obtained by solving the active optimization sub-model is used as an initial value for the reactive power optimization sub-model.

The constraints considered in the reactive power optimization sub-model includes an AC power flow constraint (2-3-2-1), a grid voltage range constraint (2-3-2-2), a voltage setting value constraint of a pilot bus (2-3-2-3).

(2-3-2-1) The AC power flow constraint has formulas of

$${P}_{i} + Δ {P}_{i}^{G} + Δ f \cdot {P}_{i}^{agc} = {V}_{i}^{2} {G}_{ii} + {\sum }_{j ∈ i}^{j \neq i} {V}_{i} {V}_{j} ( {G}_{ij} cos {θ}_{ij} + {B}_{ij} sin {θ}_{ij} ) \\ {Q}_{i} + Δ {Q}_{i}^{G} = - {V}_{i}^{2} {B}_{ii} + {\sum }_{j ∈ i}^{j \neq i} {V}_{i} {V}_{j} ( {G}_{ij} sin {θ}_{ij} - {B}_{ij} cos {θ}_{ij} )$$

where Pᵢ^{agc} represents an unbalanced power analysis coefficient of node i participating in frequency response. The unbalanced power analysis coefficient is indicative of a response of an active output of a generator to a frequency change. For example, the coefficient may be a total capacity of a generator unit connected to node i.

(2-3-2-2) The grid voltage range constraint has a formula of

Vᵢ≤Vᵢ≤V̅ᵢ̅.

(2-3-2-3) The voltage setting value constraint of a pilot bus has a formula of

Vⱼ^{p}=\hat{V}ⱼ^{p}.

In step (2-4), the reactive power optimization sub-model is solved to acquire an optimal solution of ΔQᵢ^{G}.

In step (2-5), the active power \hat{P}ᵢ and the reactive power \hat{Q}ᵢ of each node that meets the power flow result are acquired according to the results of steps (2-2) and (2-4).

$$\{ \begin{matrix}{\hat{P}}_{i} = {P}_{i} + Δ {P}_{i}^{G} + Δ f \cdot {P}_{i}^{agc} \\ {\hat{Q}}_{i} = {Q}_{i} + Δ {Q}_{i}^{G}\end{matrix}$$

The power flow adjustment is completed.

The present disclosure provides in embodiments a device for adjusting a power flow based on operation constraints. The device includes a processor, and a memory having stored therein a computer program that, when executed by the processor, causes the processor to perform the present method as described above.

It should be noted that all of the above described features and advantages for the method for adjusting a power flow based on operation constraints as described above are also applicable to the device, which will not be elaborated in detail herein.

The present disclosure provides in embodiments a computer-readable storage medium having stored therein instructions that, when executed by a processor, are configured to perform the present method as described above.

It should be noted that various embodiments or examples described in the specification, as well as features of such the embodiments or examples, may be combined without conflict. Besides above examples, any other suitable combination should be regarded in the scope of the present disclosure.

Reference throughout this specification to “an embodiment”, “some embodiments”, “one embodiment”, “another example”, “an example”, “a specific example” or “some examples” means that a particular feature, structure, material, or characteristic described in connection with the embodiment or example is included in at least one embodiment or example of the present disclosure. Thus, the appearances of the phrases such as “in some embodiments”, “in one embodiment”, “in an embodiment”, “in another example”, “in an example” “in a specific example” or “in some examples” in various places throughout this specification are not necessarily referring to the same embodiment or example of the present disclosure. Furthermore, the particular features, structures, materials, or characteristics may be combined in any suitable manner in one or more embodiments or examples.

It should be noted that, in this context, relational terms such as first and second are used only to distinguish an entity from another entity or to distinguish an operation from another operation without necessarily requiring or implying that the entities or operations actually have a certain relationship or sequence. Moreover, “comprise”, “include” or other variants are non-exclusive, thus a process, a method, an object or a device including a series of elements not only include such elements, but also include other elements which may not mentioned, or inherent elements of the process, method, object or device. If there is no further limitation, a feature defined by an expression of “include a . . . ” does not mean the process, the method, the object or the device can only have one elements, same elements may also be included.

It should be noted that, although the present disclosure has been described with reference to the embodiments, it will be appreciated by those skilled in the art that the disclosure includes other examples that occur to those skilled in the art to execute the disclosure. Therefore, the present disclosure is not limited to the embodiments.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, which may not follow a shown or discussed order according to the related functions in a substantially simultaneous manner or in a reverse order, to perform the function, which should be understood by those skilled in the art.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system including processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium include but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs. The programs may be stored in a computer readable storage medium, and the programs include one or a combination of the steps in the method embodiments of the present disclosure when run on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The storage medium mentioned above may be read-only memories, magnetic disks, CD, etc.

Although explanatory embodiments have been shown and described, it would be appreciated by those skilled in the art that the above embodiments cannot be construed to limit the present disclosure, and changes, alternatives, and modifications can be made in the embodiments without departing from scope of the present disclosure.

What is claimed is:

1. A method for adjusting a power flow based on operation constraints, comprising:
(1) establishing a power flow adjusting model comprising an objective function and constraints, comprising:
(1-1) determining the objective function of the model having a formula of
$${min}_{V , θ , Δ {P}_{i}^{G} , Δ {Q}_{i}^{G}} {\sum }_{i = 1}^{N} {{λ}_{i}^{PG} ( Δ {P}_{i}^{G} )}^{2} + {{λ}_{i}^{QG} ( Δ {Q}_{i}^{G} )}^{2}$$
where N represents the number of nodes, i represents a node number, V represents a voltage amplitude, θ represents a voltage phase angle, ΔPᵢ^{G} represents an optimal adjustment amount of an active power injected into node i, ΔQᵢ^{G} represents an optimal adjustment amount of a reactive power injected into node i, λᵢ^{PG} represents an adjustment weight of the active power injected into node i, and λᵢ^{QG} represents an adjustment weight of the reactive power injected into node i;
(1-2) determining the constraints of the model, the constraints comprising:
(1-2-1) a power flow constraint having formulas of
$${P}_{i} + Δ {P}_{i}^{G} = {V}_{i}^{2} {G}_{ii} + {\sum }_{j ∈ i}^{j \neq i} {V}_{i} {V}_{j} ( {G}_{ij} cos {θ}_{ij} + {B}_{ij} sin {θ}_{ij} )$$
$${Q}_{i} + Δ {Q}_{i}^{G} = - {V}_{i}^{2} {B}_{ii} + {\sum }_{j ∈ i}^{j \neq i} {V}_{i} {V}_{j} ( {G}_{ij} sin {θ}_{ij} - {B}_{ij} cos {θ}_{ij} )$$
where j∈i represents that node j belongs to a set of all nodes connected to node i, Gᵢⱼ and Bᵢⱼ represent a real part and an imaginary part of an upper triangular element of a node admittance matrix, respectively, Gᵢᵢ and Bᵢᵢ represent a real part and an imaginary part of a diagonal element of the node admittance matrix, respectively, Vᵢ represents a voltage amplitude of node i, θᵢⱼ represents a phase angle difference of branch ij, Pᵢ represents an active power injected into node i at a base state, and Qᵢ represents a reactive power injected into node i at a base state;
(1-2-2) a grid voltage range constraint having a formula of
Vᵢ≤Vᵢ≤V̅ᵢ̅
where Vᵢ and V̅ᵢ̅ represent a lower limit and an upper limit of a voltage amplitude of node i, respectively;
(1-2-3) a voltage setting value constraint of a pilot bus, having a formula of
Vⱼ^{p}=\hat{V}ⱼ^{p}
where Vⱼ^{p} and \hat{V}ⱼ^{p} represent an optimized voltage value and a set voltage value of an j^{th} pilot bus, respectively; and
(1-2-4) a sectional transmission power constraint having formulas of
Pₖ^{Td}=\hat{P}ₖ^{Td}
Pₘ^{Tc}≤Pₘ^{Tc}≤P̅ₘ̅^̅{̅T̅c̅}̅
where Pₖ^{Td} and \hat{P}ₖ^{Td} represent an optimized power value and a set power value of a k^{th} target tie line, respectively, Pₘ^{Tc}, Pₘ^{Tc} and P̅ₘ̅^̅{̅T̅c̅}̅ represent a power lower limit, an optimized power value and a power upper limit of an m^{th} constrained tie line, respectively;
(2) acquiring active power and reactive power of each node by using a two-stage optimization of active and reactive powers, comprising:
(2-1) establishing an active power optimization sub-model comprising an objective function and constraints, comprising:
(2-1-1) determining the objective function of the active power optimization sub-model having a formula of
$${min}_{θ , Δ {P}_{i}^{G}} {\sum }_{i = 1}^{N} {{λ}_{i}^{PG} ( Δ {P}_{i}^{G} )}^{2}$$
(2-1-2) determining the constraints of the active power optimization sub-model, the constraints comprising:
(2-1-2-1) a linearized power flow constraint having a formula of
$${P}_{i} + Δ {P}_{i}^{G} = {V}_{i}^{2} {G}_{ii} + {\sum }_{j ∈ i}^{j \neq i} {V}_{i} {V}_{j} ( {G}_{ij} + {B}_{ij} {θ}_{ij} )$$
(2-1-2-2) a tie line section power flow constraint having formulas of
Pₘ^{Tc}≤Pₘ^{Tc}≤P̅ₘ̅^̅{̅T̅c̅}̅
Pₖ^{Td}=\hat{P}ₖ^{Td}
(2-2) solving the active power optimization sub-model to acquire optimal solutions of ΔPᵢ^{G} and θ;
(2-3) establishing a reactive power optimization sub-model comprising an objective function and constraints, comprising:
(2-3-1) determining the objective function of the reactive power optimization sub-model having a formula of
$${min}_{V , θ , Δ {Q}_{i}^{G} , Δ f} {\sum }_{i = 1}^{N} {{λ}_{i}^{QG} ( Δ {Q}_{i}^{G} )}^{2}$$
where Δf represents a frequency variation, wherein an optimal solution of θ obtained by solving the active power optimization sub-model is used as an initial value;
(2-3-2) determining the constraints of the reactive power optimization sub-model, the constraints comprising:
(2-3-2-1) an AC power flow constraint having formulas of
$${P}_{i} + Δ {P}_{i}^{G} + Δ f \cdot {P}_{i}^{agc} = {V}_{i}^{2} {G}_{ii} + {\sum }_{j ∈ i}^{j \neq i} {V}_{i} {V}_{j} ( {G}_{ij} cos {θ}_{ij} + {B}_{ij} sin {θ}_{ij} ) \\ {Q}_{i} + Δ {Q}_{i}^{G} = - {V}_{i}^{2} {B}_{ii} + {\sum }_{j ∈ i}^{j \neq i} {V}_{i} {V}_{j} ( {G}_{ij} sin {θ}_{ij} - {B}_{ij} cos {θ}_{ij} )$$
where Pᵢ^{agc} represents an unbalanced power analysis coefficient of node i participating in frequency response;
(2-3-2-2) a grid voltage range constraint having a formula of
Vᵢ≤Vᵢ≤V̅ᵢ̅
(2-3-2-3) a voltage setting value constraint of a pilot bus, having a formula of
Vⱼ^{p}=\hat{V}ⱼ^{p}
(2-4) solving the reactive power optimization sub-model to acquire an optimal solution of ΔQᵢ^{G}; and
(2-5) acquiring the active power \hat{P}ᵢ and the reactive power \hat{Q}ᵢ of each node according to the optimal solutions of ΔPᵢ^{G} and ΔQᵢ^{G}:
$$\{ \begin{matrix}{\hat{P}}_{i} = {P}_{i} + Δ {P}_{i}^{G} + Δ f \cdot {P}_{i}^{agc} \\ {\hat{Q}}_{i} = {Q}_{i} + Δ {Q}_{i}^{G}\end{matrix} .$$

2. The method according to claim 1, wherein the adjustment weight of the active power is in a range of 0 to 1.

3. The method according to claim 1, wherein the adjustment weight of the reactive power is in a range of 0 to 1.

4. The method according to claim 1, wherein the active power optimization sub-model is solved by a linear programming algorithm.

5. The method according to claim 1, wherein the unbalanced power analysis coefficient is a total capacity of a generator unit connected to node i.

6. A device for adjusting a power flow based on operation constraints, comprising:
a processor; and
a memory having stored therein a computer program that, when executed by the processor, causes the processor to perform the method according to claim 1.

7. A computer-readable storage medium having stored therein instructions that, when executed by a processor, are configured to perform the method according to claim 1.
